(19) United States
(12) Patent Application Publication
(10) Pub. No.: US 2026/0076357 A1
(43) Pub. Date: Mar. 19, 2026

(54) GLUEBOARD WITH VIRTUAL OPENING AND METHODS OF MAKING SAME

(71) Applicant: TYTON, LLC, Bedford, TX (US)

(72) Inventors: Ethan VICKERY, Colleyville, TX (US); Eric SNELL, Colleyville, TX (US)

(21) Appl. No.: 19/329,323

(22) Filed: Sep. 15, 2025

Related U.S. Application Data
(60) Provisional application No. 63/695,281, filed on Sep. 16, 2024.

(51) Int. Cl. A01M 23/00

(52) U.S. Cl. CPC A01M 23/005

(57) ABSTRACT

Glueboard apparatuses, and methods of making glueboard apparatuses, with a substrate and an adhesive layer, and a contrasting region visible on or through the adhesive layer to attract rodents. The contrasting region can be a colored region that is darker than or lighter than surrounding areas of the adhesive layer, and/or can include a raised ring that extends upward from the adhesive layer away from the substrate.

### CROSS-REFERENCE TO RELATED APPLICATIONS

This application claims the benefit of priority of U.S. Provisional Patent Application No. 63/695,281, filed Sep. 16, 2024, which is hereby incorporated by reference in its entirety.

### FIELD OF INVENTION

The present invention relates generally to pest management and more particularly, but not by way of limitation, to improved glueboards for rodent capture and methods for making such glueboards.

### BACKGROUND

Pests such as insects, mice, rats, and other small creatures can cause problems for both residential and commercial buildings and their occupants. There are a variety of ways to deal with infestations of pests.

Applying pesticides around the boundaries of buildings or other areas is one method to deter pests from infiltrating those spaces. However, pesticide use may be undesired in certain economic sectors and businesses, for example, in sensitive environments such as food preparation areas, childcare centers, hospitals, and nurseries.

An alternative approach to pest control involves using devices like traps. Some such traps use adhesive surfaces to capture pests. For example, glueboards have been used to capture insects and rodents. However, the effectiveness of such glueboards depend on a rodent actually stepping onto the glueboard to become trapped by the adhesive.

### SUMMARY

Glueboards have been known for decades with little change in overall configuration. The present glueboard apparatuses, however, include a physical feature (in the form of a visually contrasting region) that attract rodents, independent of any scent or other bait, to increase the likelihood that a rodent will step onto the adhesive surface and become trapped. As such, the present glueboard apparatuses can be used to trap rodents without any added scent or other bait, or can include one or more additional scents or other baits in addition to the physical feature. Such physical features can include (a) an annular ring that extends above the adhesive side of the glueboard, (b) a region—visible on the adhesive side of the glueboard—that is darker than or lighter than surrounding portions of the glueboard, or (c) both of feature (a) and (b). For example, some configurations of the present glueboards may include an annular ring that is darker than or lighter than surrounding portions of the glueboard. Alternatively or additionally, some configurations of the present glueboards may include both an annular ring and a contrasting region of the glueboard that is darker than or lighter than portions of the glueboard surrounding the contrasting region and/or the ring.

A contrasting region may be formed by coloring the adhesive layer of the glueboard, coloring the substrate below the adhesive layer, or coloring both the adhesive layer and the substrate. Coloring may be applied, for example, by printing, dyeing, painting, or otherwise applying a pigment to or into, by burning or charring, by applying a sticker to, or otherwise darkening or lightening the portion of the substrate and/or glueboard in the contrasting region to cause the contrasting region to have a color that is darker than or lighter than portions of the glueboard (e.g., adhesive layer, substrate, or both) surrounding the contrasting region. In some configurations, the contrasting region is colored with a gradient to give the impression of depth, for example, to mimic the appearance of or otherwise provide the visual illusion of being a tunnel or hole in the glueboard. Such a contrasting region may, for example, occupy a surface area that comprises a minority of the total surface area of the adhesive layer, may be spaced inward from the edges of the adhesive layer and/or the substrate of the glueboard (e.g., such that the contrasting region does not extend to any edge of the adhesive layer or the substrate).

The present contrasting regions are typically of a size that would, if a hole or tunnel, would accommodate the passage of a rodent intended to be captured by the glueboard.

In some configurations of the present glueboard apparatuses for pest capture, the glueboard apparatus comprises: a substrate having an upper side and a lower side; and an adhesive layer covering at least a portion of a surface area on the upper side of the substrate; where the glueboard apparatus is configured such that a contrasting region is visible on or through the adhesive layer.

In some of the foregoing configurations of the present glueboard apparatuses for pest capture, a majority of the adhesive layer has a first color and/or pattern, the contrasting region comprises a region with a second color that is darker than the first color, that is surrounded by the first color and/or pattern, or both.

In some of the foregoing configurations of the present glueboard apparatuses for pest capture, the adhesive layer is transparent or translucent, and where the contrasting region comprises a shape on the upper side of the substrate and the shape has a shape coloring and is surrounded by a color that is lighter than a color of the shape. In some such configurations, the shape coloring comprises a gradient from a darker color around a majority of a perimeter of the shape to a lighter color at an interior of the shape. In some such configurations, the shape coloring is configured to give the illusion of depth.

In some of the foregoing configurations of the present glueboard apparatuses for pest capture, the contrasting region includes an annular ring that extends from a surface of the adhesive layer in a direction away from the substrate.

In some of the foregoing configurations of the present glueboard apparatuses for pest capture, the contrasting region is circular.

In some of the foregoing configurations of the present glueboard apparatuses for pest capture, the substrate extends between a first end and a second end, the first end having a slot and the second end having a tab configured to extend into the slot. In some such configurations, the slot has a length and the tab has a width that is larger than the length of the slot.

In some of the foregoing configurations of the present glueboard apparatuses for pest capture, the adhesive covers a majority of a surface area of the upper side of the substrate. In some such configurations, the adhesive layer is substantially rectangular.

In some of the foregoing configurations of the present glueboard apparatuses for pest capture, a surface of the upper side of the substrate is substantially planar. In some such configurations, the substrate is planar.

Some configurations of the present pest management apparatuses comprise: a base; one of the foregoing configurations of the present glueboard apparatuses coupled to the base; and a lid pivotably coupled to the base between an open configuration and a closed configuration in which the pest management apparatus defines an interior region in which the adhesive layer of the glueboard apparatus faces upward toward the interior region; where, when the lid is in the closed configuration, the apparatus defines one or more openings through which a rodent can access the interior region.

In some of the foregoing configurations of the present pest management apparatuses, the base has a bottom that defines an opening, and the glueboard apparatus spans the opening in the base.

In some implementations of the present methods of manufacturing a glueboard apparatus for pest capture, the method comprises: applying a layer of adhesive to an upper side of a substrate having a contrasting region such that: the adhesive layer covers at least a portion of a surface area on the upper side of the substrate, and the contrasting region is visible through the adhesive layer.

In some of the foregoing implementations of the present methods, a majority of the upper side of the substrate has a first color, the contrasting region comprises a region with a second color that is darker than the first color and that is surrounded by the first color.

In some of the foregoing implementations of the present methods, the shape coloring comprises a gradient from a darker color around a majority of a perimeter of the shape to a lighter color at an interior of the shape. In some such implementations, the shape coloring is configured to give the illusion of depth.

In some of the foregoing implementations of the present methods, the method further comprises: coloring the substrate, prior to applying the layer of adhesive, to define the contrasting region.

In some of the foregoing implementations of the present methods, the method comprises: defining a contrasting region on an adhesive layer. In some such implementations, the adhesive layer is coupled to a substrate. Some such implementations further comprise: applying the layer of adhesive to an upper side of the substrate such that the adhesive layer covers at least a portion of a surface area on the upper side of the substrate.

In some of the foregoing implementations of the present methods, defining the contrasting region comprises: coupling an annular ring to the adhesive layer such that the ring extends from a surface of the adhesive layer in a direction away from the substrate.

In others of the foregoing implementations of the present methods, defining the contrasting region comprises: coloring a portion of the surface of the adhesive layer.

In some of the foregoing implementations of the present methods, the contrasting region is circular.

In some of the foregoing implementations of the present methods, the substrate extends between a first end and a second end, the first end having a slot and the second end having a tab configured to extend into the slot. In some such implementations, the slot has a length and the tab has a width that is larger than the length of the slot.

In some of the foregoing implementations of the present methods, the adhesive covers a majority of a surface area of the upper side of the substrate.

In some of the foregoing implementations of the present methods, the adhesive layer is substantially rectangular.

In some of the foregoing implementations of the present methods, a surface of the upper side of the substrate is substantially planar. In some such implementations, the substrate is planar.

The terms “a” and “an” are defined as one or more unless this disclosure explicitly requires otherwise.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, an apparatus or component thereof that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale, unless otherwise noted, meaning that in each of the figures the sizes of the elements are accurate relative to each other at least for the depicted embodiments.

FIG. 1 is a top view of one example of the present glueboard apparatuses.

FIG. 2A is a cross-sectional view of the glueboard apparatus of FIG. 1 taken along the line 2-2 of FIG. 1.

FIG. 2B is a cross-sectional view of an alternative example of the glueboard apparatus of FIG. 1, taken along the line 2-2 of FIG. 1.

FIG. 3 is a top view of a further example of the present glueboard apparatuses.

FIG. 4 is a top view of a further example of the present glueboard apparatuses.

FIG. 5 is a cross-sectional view of the glueboard apparatus of FIG. 4 taken along the line 5-5 of FIG. 4.

FIG. 6 is an upper perspective view of a further example of the present glueboard apparatuses.

FIG. 7 is an upper perspective view of a pest management apparatus with a glueboard apparatus of FIG. 1, shown with the pest management apparatus in an open configuration.

FIG. 8 is an upper perspective view of the pest management apparatus with a glueboard apparatus of FIG. 4, shown with the pest management apparatus in an open configuration.

FIG. 9A is a perspective view of one of the present glueboard apparatuses.

FIG. 9B is a perspective view of an alternative one of the present glueboard apparatuses.

### DETAILED DESCRIPTION OF ILLUSTRATIVE EMBODIMENTS

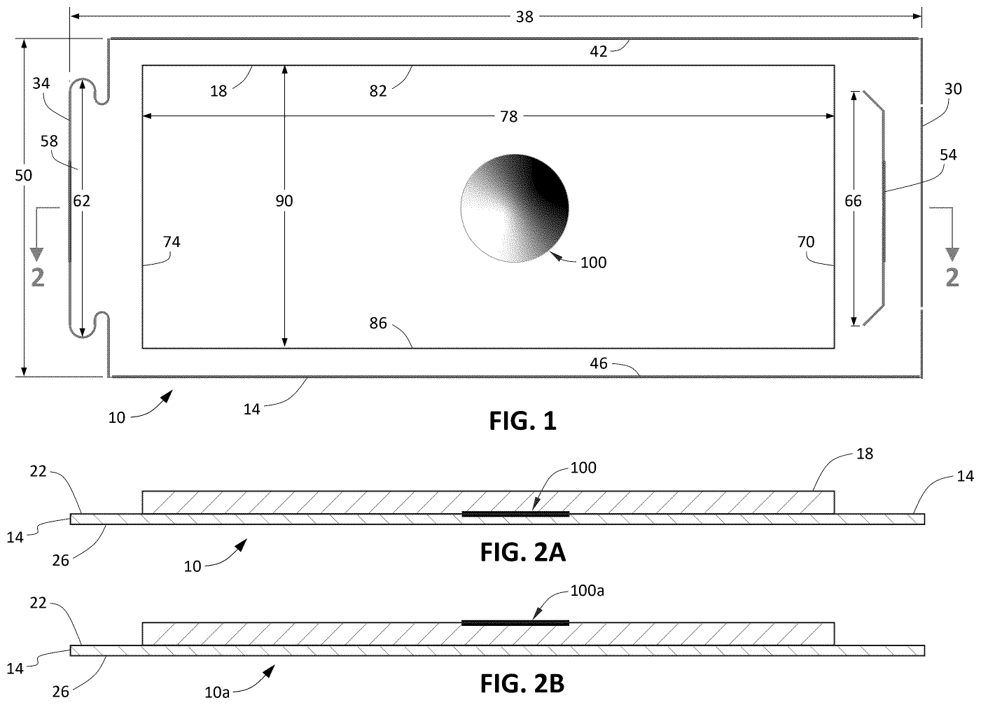

Referring now to the drawings, and more particularly to FIGS. 1 and 2A, shown therein and designated by the reference numeral 10 is a first example of the present glueboard apparatuses. FIG. 1 shows a top view apparatus 10, and FIG. 2A shows a cross-sectional view of apparatus 10 taken along the line 2-2 of FIG. 1. In the example shown, apparatus 10 comprises a substrate 14 and an adhesive layer 18. Substrate 14 has an upper side 22 and a lower side 26. In the depicted example, upper side 22 is substantially planar (is defined by a substantially planar surface) and substrate 14 is also substantially planer (i.e., lower side 26 is also substantially planar and is parallel to upper side 22). In other configurations, the substrate may have upper and lower sides that are not planar (e.g., dimpled, creped, ridged, or otherwise textured).

In the depicted example, substrate 14 comprises paper or cardboard (comprising cellulosic fibers), such as, for example, a recyclable and/or biodegradable paper or cardboard. In other configurations, the substrate can comprise plastic, such as, for example, a plastic sheet or a plastic tray with a raised edge around the outer peripheral edge of the adhesive layer (e.g., and also around a perimeter of the plastic tray). As shown, substrate 14 extends between a first end 30 and a second end 34 to define a length 38, and extends between a first side 42, and a second side 46 to define a width 50. In the depicted example, a slot 54 is defined through a portion of substrate 14 closer to first end 30 than to second end 34; and a tab 58 is configured at second end 34 of substrate 14 with tab 58 configured to extend into slot 54. With the tab and slot, glueboard apparatus 10 is can be folded into a tunnel-like configuration in which tab 58 extends through slot 54 to define a closed shape with open ends (defined at sides 42 and 46). As shown, tab 58 has a width 62 that is larger than a length 66 of slot 54 to resist separation of first end 30 from second end 34 when glueboard apparatus 10 is in the folded tunnel-like configuration.

In this example, adhesive layer 18 covers at least a portion of a surface area on upper side 22 of substrate 14. As shown, adhesive layer 18 extends between a first end 70 and a second end 74 to define a length 78, and extends between a first side 82 and a second side 86 to define a width 90. As shown, length 78 of adhesive layer 18 extends a majority of length 38 of substrate 14, and width 90 extends a majority of width 50 of substrate 14, such that adhesive layer 18 is substantially rectangular and covers a majority of the surface area of upper side 22 of substrate 14. In other configurations, adhesive layer 18 may include any suitable shape (e.g., square, wavy, fanciful, or the like), and/or may include a plurality of shapes that are spaced apart across the upper surface of the substrate (e.g., a checkerboard pattern of squares or rectangles of adhesive, a plurality of strips of adhesive elongated in the direction of width 90 and spaced in the direction of length 78, a plurality of strips of adhesive elongated in the direction of length 78 and spaced in the direction of width 90, a plurality of dots or circles of adhesive spaced in the direction of length 78 and in the direction of width 90, and/or the like).

As shown, apparatus 10 also includes a contrasting region 100 that is visible on or through adhesive layer 18. In this example, a majority of adhesive layer 18 has a first color, and contrasting region 100 has a second color that is darker than the first color of the adhesive layer 18 and is surrounded by the first color of the adhesive layer. In the depicted example, substrate 14 has a first color (e.g., white), and adhesive layer 18 is transparent or translucent such that the adhesive layer appears to be white (or tinted by a different color, if any, in adhesive layer 18), while contrasting region 100 has a shape coloring (e.g., a gradient from black or dark gray around a majority of the perimeter of the contrasting region to white or light gray in the interior of the contrasting region) that is darker than the substrate and adhesive layer appear to be surrounding contrasting region 100. With this gradient, the shape coloring of contrasting region 100 is configured to give the illusion of depth (e.g., similar to the appearance of an opening or tunnel). Alternatively, a majority of adhesive layer 18 outside of contrasting region 100 can comprise a pattern or design such that further contrast is present between the majority of the adhesive layer and contrasting region 100. In this example, contrasting region 100 is circular and has a transverse dimension that is a diameter. In other configurations, the contrasting region may be oval, square, rectangular, or any other shape, with corresponding transverse dimensions. For example, the diameter of circular contrasting region 100, or the maximum transverse dimension of a non-circular contrasting region, can in some configurations be at least any one of, or between any two of: 0.8, 1.0, 1.25, 1.5, 1.75, 2, 2.25, 2.5, 2.75, 3, or more inches.

As shown in FIG. 2A, contrasting region 100 of apparatus 10 is defined by a coloring applied to substrate 14 before the application of adhesive layer 18. For example, contrasting region 100 may be printed on substrate 14 or may be applied to substrate 14 in the form of a sticker, before adhesive layer 18 is added to substrate 14.

Alternatively, as shown in FIG. 2B, a contrasting region 100a of apparatus 10a may be printed on or dyed into adhesive layer 18 after adhesive layer 18 is added to substrate 14. Apparatus 10a is otherwise substantially similar to apparatus 10.

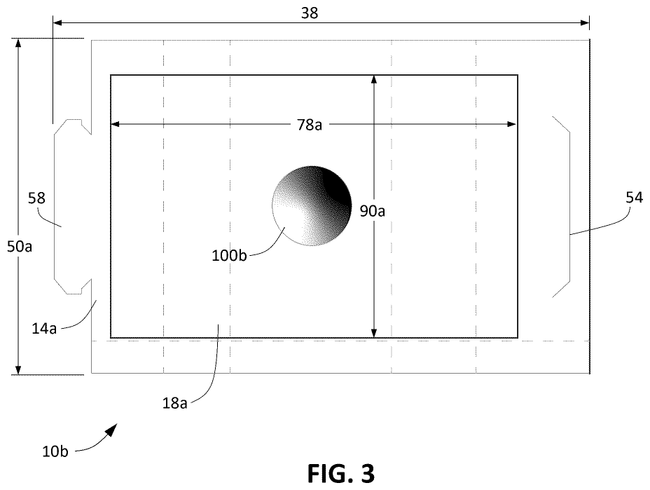

FIG. 3 is a top view of a further example 10b of the present glueboard apparatuses. Apparatus 10b is substantially similar to apparatus 10, with the exception that substrate 14a and adhesive layer 18a of apparatus 10b have different aspect ratios and contrasting region 100b is smaller than contrasting region 100 and 100a. As shown, lengths 38a and 78a are smaller relative to widths 50a and 90a, respectively, and widths 50a and 90a are larger relative to lengths 38a and 78a. Stated another way, the width: length aspect ratio of substrate 14a is larger than the width: length aspect ratio of substrate 14, and the width: length aspect ratio of adhesive layer 18a is larger than the width: length aspect ratio of adhesive layer 18.

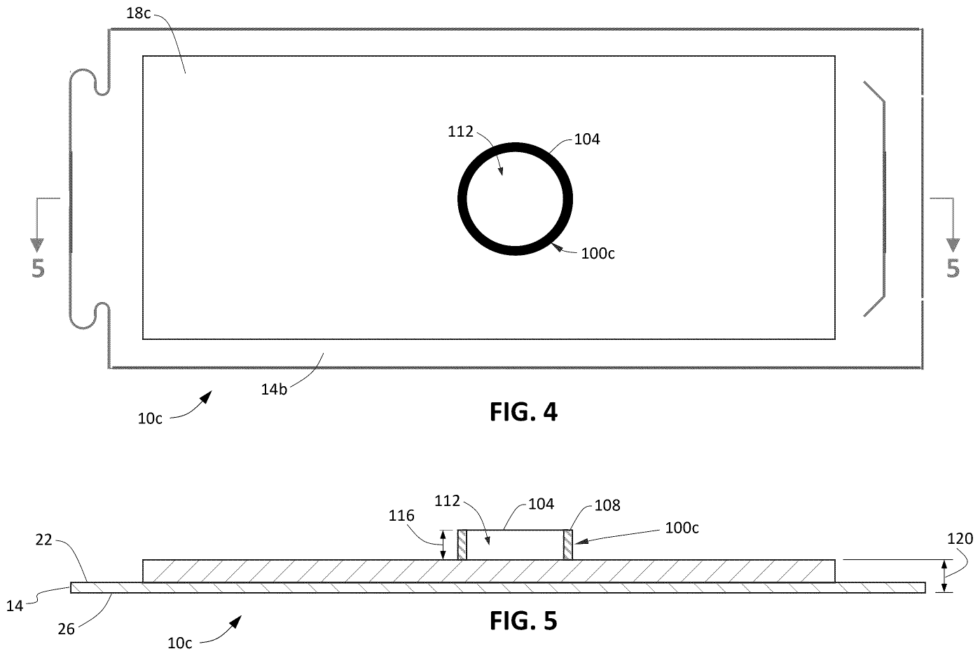

Referring now to FIGS. 4 and 5, FIG. 4 is a top view of a further example 10c of the present glueboard apparatuses, and FIG. 5 is a cross-sectional view of apparatus 10c taken along the line 5-5 of FIG. 4. Apparatus 10c is substantially similar to apparatus 10, with the exception that contrasting region 100c of apparatus 10c includes an annular ring 104 that extends from a surface of adhesive layer 18b in a direction away from substrate 14. In this example, ring 104 has a sidewall 108 defining a circular perimeter and a hollow interior 112 in which adhesive layer 18b remains exposed. In this example, ring 104 defines contrasting region 100c in that ring 104 is darker than surrounding portions of adhesive layer 18b, but portions of adhesive layer 18b within the ring (within interior 112) are the same color as portions of adhesive layer 18b outside the ring. In other configurations, surrounding portions of the adhesive layer may be darker than the ring (and the ring lighter than surrounding portions of the adhesive layer), and/or portions of the adhesive layer within interior 112 of ring 104 may be darker than or lighter than portions of the adhesive layer outside ring 104 (e.g., substrate 14b and/or adhesive layer 18b may be colored to achieve the contrast). Additionally, while ring 104 is shown as circular, in other configurations, the ring may define a perimeter with other shapes (e.g., square, rectangular, fanciful, or the like). In this example, ring 104 is circular and has an interior transverse dimension that is a diameter. In other configurations, the contrasting region may be oval, square, rectangular, or any other shape, with corresponding transverse dimensions. For example, the inner diameter of circular ring 104, or the maximum inner transverse dimension of a non-circular ring, can in some configurations be at least any one of, or between any two of: 0.8, 1.0, 1.25, 1.5, 1.75, 2, 2.25, 2.5, 2.75, 3, or more inches.

As shown in FIG. 5, in this example, ring 104 has a height 116 that is greater than the combined thickness 120 of substrate 14b and adhesive layer 18b. For example, in this configuration, height 116 of the ring can in some configurations be at least any one of, or between any two of: 0.1, 0.2, 0.3, 0.4, 0.5, 0.6, 0.7, 0.8, 0.9, 1.0, or more inches. In some configurations, the thickness of the wall of the ring (in the direction of the transverse dimension), is smaller than height 116 and may, for example, be smaller than one of, or between any two of: 0.05, 0.1, 0.15, 0.2,0.25, 0.3, 0.4, or 0.5 inches.

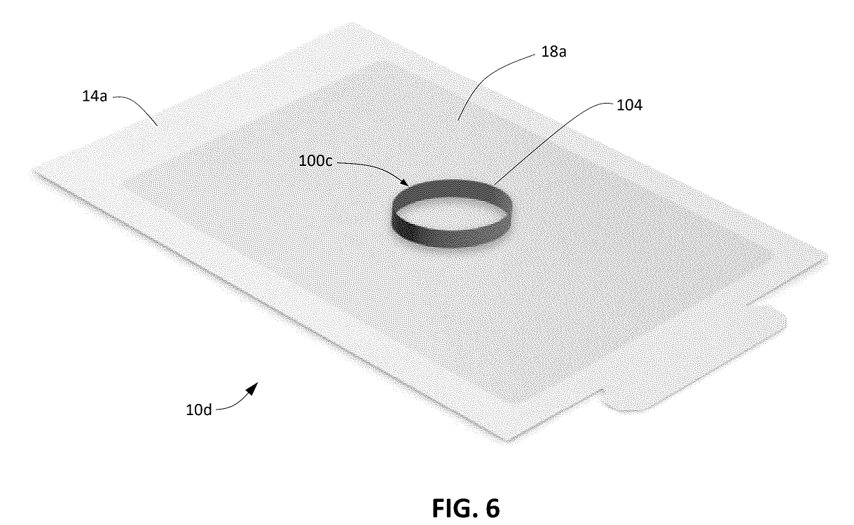

FIG. 6 is an upper perspective view of a further example 10d of the present glueboard apparatuses. Apparatus 10d is substantially similar to apparatus 10c, with the exception that substrate 14a and adhesive layer 18a have dimensions and corresponding aspect ratios that are similar to substrate 14a and adhesive layer 18a of FIG. 3.

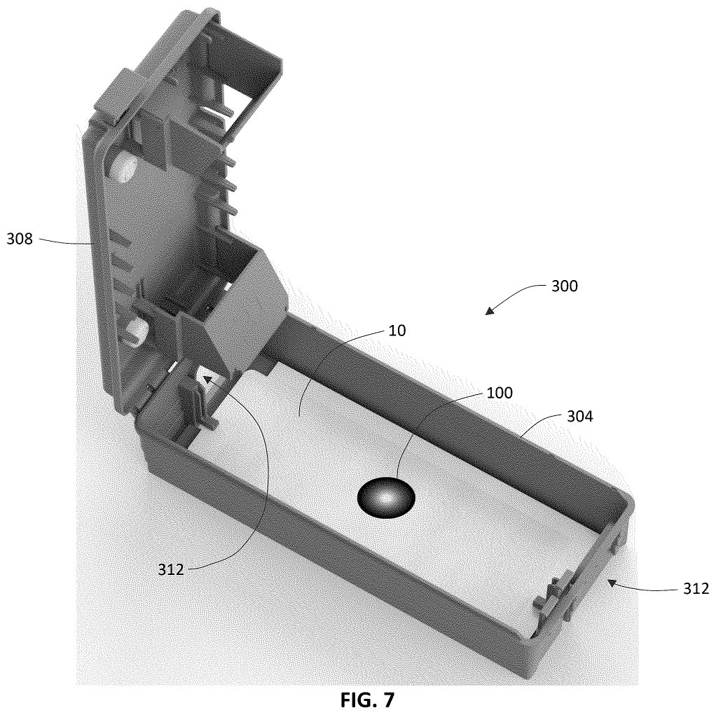

FIG. 7 is an upper perspective view of a pest management apparatus 300 with a glueboard apparatus 10a of FIG. 1, in which pest management apparatus 200 is shown in an open configuration. As shown pest management apparatus 300 includes a base 304, a glueboard 10 disposed in base 304, and a lid 308 pivotably coupled to base 304 between an open configuration (shown) and a closed configuration in which the pest management apparatus defines an interior region in which the adhesive layer of glueboard apparatus 10 faces upward toward the interior region. Additionally, when lid 308 is in the closed configuration (not shown), pest management apparatus 300 defines one or more openings 312 through which a rodent can access the interior region (and glueboard apparatus 10).

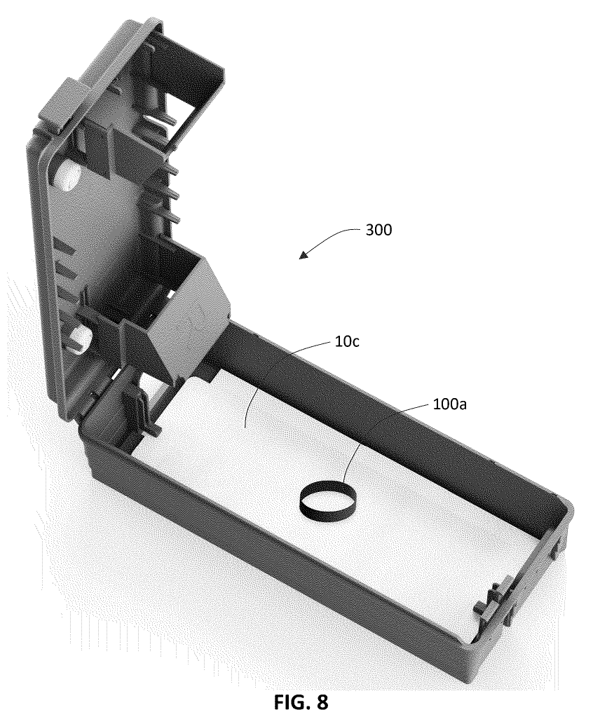

FIG. 8 is an upper perspective view of pest management apparatus 300 with a glueboard apparatus 10c of FIG. 4, in which pest management apparatus 300 is shown in an open configuration.

Additional details about pest management apparatus 300 can be found in United States Patent Application Publication No. US 2024/0114889 A1 published Apr. 11, 2024, which is incorporated by reference in its entirety (corresponding to U.S. patent application Ser. No. 18/481,837, filed Oct. 5, 2023, which is also incorporated by reference in its entirety). An additional example of a pest management apparatus with which the present glueboard apparatuses can be used can be found in U.S. Provisional Patent Application No. 63/589,263 , filed Oct. 10, 2023, which is incorporated by reference in its entirety.

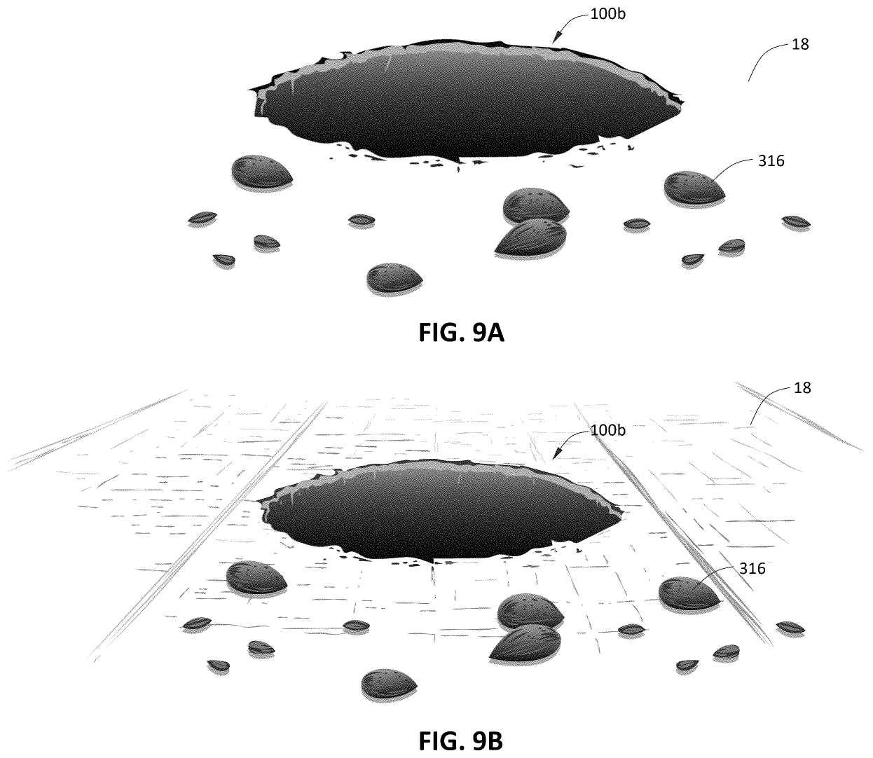

FIGS. 9A and 9B depict perspective views of portions of additional variations the present pest management apparatuses. In FIG. 9A, adhesive layer 18 is white, or is clear with a white substrate (e.g., 14) underneath. The white layer can provide contrast with contrasting region 100b, thereby enhancing the illusionary depth effect of the contrasting region to better attract potential pests. Additionally, in the depicted configurations, contrasting region 100b includes depictions 316 of food giving the illusion of that bait being scattered on adhesive layer 18 to further increase the likelihood that a pest will step onto the adhesive layer. For example, depictions 316 of food can comprise seeds, grains, nuts, or any combination thereof to attract pests. FIG. 9B is substantially similar to FIG. 9A, with the exception of an alternative design for the majority of the adhesive layer 18 (or substrate 14, depending on the preferred manufacturing method). In this depiction, a pattern is provided on adhesive layer 18 or substrate 14 to provide further contrast between the adhesive layer and contrasting region 100.

The present glueboard apparatuses can be manufactured by adding the formation of contrasting regions (100, 100a, 100b, 100c) to various methods and steps for manufacturing glueboard apparatuses.

In some implementations of the present methods of manufacturing a glueboard apparatus for pest capture, the method comprises: applying a layer of adhesive (e.g., 18, 18a, 18b, 18c) to an upper side (e.g., 22) of a substrate (e.g., 14, 14a) having a contrasting region (e.g., 100, 100b) such that: the adhesive layer (e.g., 18, 18a) covers at least a portion of a surface area on the upper side (e.g., 22) of the substrate, and the contrasting region (e.g., 100, 100b) is visible through the adhesive layer (e.g., 18, 18a). Some implementations of such methods further comprise: coloring the substrate (e.g., 14, 14a), prior to applying the layer of adhesive (e.g., 18, 18a), to define the contrasting region (e.g., 100, 100b).

In other implementations of the present methods of manufacturing a glueboard apparatus for pest capture, the method comprises: defining a contrasting region (e.g., 100a, 100c) on an adhesive layer (e.g., 18, 18a) that is coupled to a substrate (e.g., 14, 14a), for example by coloring a surface of the adhesive layer that is opposite the substrate. Some such implementations can optionally further comprise applying the layer of adhesive (e.g., 18, 18a) to an upper side of the substrate (e.g., 14, 14a, 14b) such that the adhesive layer (e.g., 18, 18a) covers at least a portion of a surface area on the upper side (e.g., 22) of the substrate. In some such implementations, defining the contrasting region (e.g., 100a, 100b) comprises: coloring a portion of the surface of the adhesive layer (e.g., 18, 18a). In other such implementations, defining the contrasting region (e.g., 100c) comprises: coupling an annular ring (e.g., 104) to the adhesive layer (e.g., 18, 18a) such that the ring extends from a surface of the adhesive layer in a direction away from the substrate (e.g., 14, 14a).

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the apparatuses and methods are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus-or step-plus-function limitations, unless such a limitation is explicitly recited in a given claim using the phrase(s) “means for” or “step for,” respectively.

1. A glueboard apparatus for pest capture, the glueboard apparatus comprising:
a substrate having an upper side and a lower side; and
an adhesive layer covering at least a portion of a surface area on the upper side of the substrate;
where the glueboard apparatus is configured such that a contrasting region is visible on or through the adhesive layer.

2. The glueboard apparatus of claim 1, where the adhesive layer is transparent or translucent, and where the contrasting region comprises a shape on the upper side of the substrate and the shape has a shape coloring and is surrounded by a color that is lighter than a color of the shape.

3. The glueboard apparatus of claim 2, where the shape coloring comprises a gradient from a darker color around a majority of a perimeter of the shape to a lighter color at an interior of the shape.

4. The glueboard apparatus of claim 1, where the contrasting region includes an annular ring that extends from a surface of the adhesive layer in a direction away from the substrate.

5. The glueboard apparatus of claim 1, where the substrate extends between a first end and a second end, the first end having a slot and the second end having a tab configured to extend into the slot.

6. The glueboard apparatus of claim 1, where the adhesive covers a majority of a surface area of the upper side of the substrate.

7. The glueboard apparatus of claim 1, where a surface of the upper side of the substrate is substantially planar.

8. A pest management apparatus comprising:
a base;
a glueboard apparatus of claim 1 coupled to the base; and
a lid pivotably coupled to the base between an open configuration and a closed configuration in which the pest management apparatus defines an interior region in which the adhesive layer of the glueboard apparatus faces upward toward the interior region;
where, when the lid is in the closed configuration, the apparatus defines one or more openings through which a rodent can access the interior region.

9. The pest management apparatus of claim 8, where the base has a bottom that defines an opening, and the glueboard apparatus spans the opening in the base.

10. A method of manufacturing a glueboard apparatus for pest capture, the method comprising:
applying a layer of adhesive to an upper side of a substrate having a contrasting region such that:
the adhesive layer covers at least a portion of a surface area on the upper side of the substrate, and
the contrasting region is visible through the adhesive layer.

11. The method of claim 10, where a majority of the upper side of the substrate has a first color, the contrasting region comprises a region with a second color that is darker than the first color and that is surrounded by the first color.

12. The method of claim 10, where the shape coloring comprises a gradient from a darker color around a majority of a perimeter of the shape to a lighter color at an interior of the shape.

13. The method of claim 12, where the shape coloring is configured to give the illusion of depth.

14. The method of claim 10, further comprising:
coloring the substrate, prior to applying the layer of adhesive, to define the contrasting region.

15. A method of manufacturing a glueboard apparatus for pest capture, the method comprising:
defining a contrasting region on an adhesive layer.

16. The method of claim 15, where the adhesive layer is coupled to a substrate, and the method further comprises:
applying the layer of adhesive to an upper side of the substrate such that the adhesive layer covers at least a portion of a surface area on the upper side of the substrate.

17. The method of claim 15, where defining the contrasting region comprises:
coupling an annular ring to the adhesive layer such that the ring extends from a surface of the adhesive layer in a direction away from the substrate.

18. The method of 16, where defining the contrasting region comprises:
coloring a portion of the surface of the adhesive layer.

19. The method of claim 15, where the adhesive covers a majority of a surface area of the upper side of the substrate.
